(19) United States
(12) Patent Application Publication
(10) Pub. No.: US 2024/0055621 A1
(43) Pub. Date: Feb. 15, 2024

(54) FUEL CELL STACK AND PRODUCTION METHOD

(71) Applicant: Robert Bosch GmbH, Stuttgart (DE)

(72) Inventors: Andreas Ringk, Bamberg (DE); Anton Ringel, Bamberg (DE)

(21) Appl. No.: 18/257,952

(22) PCT Filed: Dec. 16, 2021
(86) PCT No.: PCT/EP2021/086089

§ 371 Date: Jul. 28, 2023

(30) Foreign Application Priority Data
Dec. 17, 2020 (DE) 10 2020 216 104.6

(51) Int. Cl. H01M 8/0297; H01M 8/04119; H01M 8/0228

(52) U.S. Cl. CPC H01M 8/0297; H01M 8/04149; H01M 8/0228

(57) ABSTRACT

The invention relates to a fuel cell stack (1) comprising at least one bipolar plate (3), at least one gas diffusion layer (5) and at least one electrolyte, in particular at least one membrane (7), wherein a coating (9) is arranged as a connecting means between the at least one bipolar plate (3) and the at least one gas diffusion layer (5) and the coating (9) is electrically conductive. The invention further relates to a method for producing the fuel cell stack (1).

### BACKGROUND

The invention relates to a fuel cell stack comprising at least one bipolar plate, at least one gas diffusion layer and at least one electrolyte, in particular at least one membrane, wherein a coating is arranged between the at least one bipolar plate and the at least one gas diffusion layer. The invention further relates to a method used for producing the fuel cell stack.

A fuel cell is an electrochemical cell that converts the chemical reaction energy of a continuously supplied fuel and an oxidizing agent into electrical energy. A fuel cell is thus an electrochemical energy converter. In known fuel cells, hydrogen (H₂) and oxygen (O₂) are in particular converted to water (H₂O), electrical energy, and heat.

Proton exchange membrane (PEM) fuel cells are known, among others. Proton exchange membrane fuel cells comprise a centrally arranged membrane that is permeable to protons, i.e., hydrogen ions. The oxidizing agent, in particular atmospheric oxygen, is thereby spatially separated from the fuel, in particular hydrogen.

Furthermore, solid oxide fuel cells (SOFC) are known. SOFC fuel cells have a higher operating temperature and exhaust temperature than PEM fuel cells and are in particular used in stationary operation.

Fuel cells comprise an anode and a cathode. The fuel is supplied to the fuel cell at the anode and catalytically oxidized with loss of electrons to form protons that reach the cathode. The lost electrons are discharged from the fuel cell and flow via an external circuit to the cathode.

A voltage is in this case applied between the anode and the cathode of the fuel cell. In order to increase the voltage, a plurality of fuel cells can be mechanically arranged one behind the other to form a fuel cell stack, also known as a stack, and electrically connected in series.

O₂+4H⁺+4e⁻→2H₂O

A fuel cell stack usually comprises end plates that press the individual fuel cells together and provide stability to the fuel cell stack. The end plates also serve as a positive or negative pole of the fuel cell stack for discharging the current.

The electrodes, i.e., the anode and the cathode, and the membrane may be structurally assembled to form a membrane-electrode assembly (MEA). Often, the membrane is coated with a catalyst and is referred to as a Catalyst Coated Membrane (CCM).

Fuel cell stacks furthermore comprise bipolar plates, also referred to as gas diffuser plates. Bipolar plates serve to distribute the fuel evenly to the anode and to distribute the oxidizing agent evenly to the cathode. Furthermore, bipolar plates usually have a surface structure, for example channel-like structures, for distributing the fuel and the oxidizing agent to the electrodes. Bipolar plates typically have a undulating profile in which channels and connecting portions alternate. The channel-like structures also serve to drain the water produced during the reaction. Furthermore, due to the channel-like structures of the bipolar plates, a cooling medium for dissipating heat can be conducted through the fuel cell.

In addition to the media guidance with respect to oxygen, hydrogen, and water, the bipolar plates ensure a planar electrical contact to the electrolytes.

A fuel cell stack typically comprises up to a few hundred individual fuel cells stacked one on top of the other in layers as so-called sandwiches. As a rule, the individual fuel cells comprise one MEA as well as one respective bipolar plate half on the anode side and on the cathode side. In particular, a fuel cell comprises an anode monopolar plate and a cathode monopolar plate, which are merged and form a bipolar plate.

Typically, the gas diffusion layer and bipolar plate are pressed together in the fuel cell stack, thereby creating an electrical contact in the form of a pressing contact. The transition resistance between the gas diffusion layer and the bipolar plate decreases with higher pressing force. However, the higher the pressing force, the greater the risk of damage to the gas diffusion layer, which is typically made of carbon fibers glued together by means of Teflon, for example. In particular, the risk of damage to the carbon fibers increases. Moreover, heavy compression decreases the porosity of the gas diffusion layer, which can lead to a poorer gas distribution in the fuel cell stack. The gas distribution over the surface, in particular the membrane, also becomes inhomogeneous.

The effects of pressing power on the gas diffusion layer are described in Mason et al., “Effect of Clamping Pressure on Ohmic Resistance and Compression of Gas Diffusion Layers for Polymer Electrolyte Fuel Cells”, Journal of Power Sources, Volume 219, pages 52-59, 2012.

Gas diffusion layers (GDL) and catalyst coated membranes (CCM) are known to be glued together to form the membrane electrode unit, which is then placed on and stacked with the bipolar plate. Both carbon fibers and Teflon, however, have poor bonding properties, as few adhesive forces can be built up.

DE 11 2005 002 974 B4 describes a method for increasing the adhesive force between elements to be bonded in a fuel cell membrane-electrode assembly.

DE 102 24 452 C1 is directed to a proton-conductive polymer membrane. A catalyst-coated, proton-conducting polymer membrane is part of a membrane-electrode unit that has a gas diffuser structure and a diffusion layer on both the cathode and anode sides. Glue properties of a catalyst layer or membrane are improved.

### SUMMARY

A fuel cell stack is proposed comprising at least one bipolar plate, at least one gas diffusion layer and at least one electrolyte, in particular at least one membrane, wherein a coating is arranged as a connecting means between the at least one bipolar plate and the at least one gas diffusion layer and the coating is electrically conductive.

Furthermore, a method for producing the fuel cell stack is proposed comprising the following steps:
providing the at least one bipolar plate, the at least one gas diffusion layer and the at least one electrolyte, in particular the at least one membrane,
applying the electrically conductive coating comprising a coating material to the at least one bipolar plate and/or the at least one gas diffusion layer,
stacking the at least one bipolar plate, the at least one gas diffusion layer and the at least one electrolyte, particularly the at least one membrane, and connecting the at least one bipolar plate and the at least one gas diffusion layer by means of the electrically conductive coating such that an electrical contact is made between the at least one bipolar plate and the at least one gas diffusion layer, and
curing the coating material.

The at least one bipolar plate and the at least one gas diffusion layer are preferably connected to each other in a material-locking and/or form-locking manner by means of the coating. More preferably, the at least one bipolar plate and the at least one gas diffusion layer are connected to each other in a material-locking manner by means of the coating. Further preferably, the at least one gas diffusion layer and the at least one bipolar plate are connected to one another with a contact pressure of not greater than 1.4 N/mm 2. Preferably, the at least one bipolar plate and the at least one gas diffusion layer are stacked with a contact pressure of not less than 1.4 N/mm². Particularly preferably, the at least one bipolar plate and the at least one gas diffusion layer are connected to each other exclusively in a material-locking and/or form-locking manner.

The gas diffusion layer preferably comprises fibers, in particular carbon fibers, and a matrix comprising in particular Teflon. Further preferably, the at least one gas diffusion layer consists of carbon fibers and Teflon.

Preferably, the coating can be molded, in particular formed, to the fibers of the at least one gas diffusion layer, thereby allowing the at least one bipolar plate and the at least one gas diffusion layer to be connected in a form-locking manner.

The material-locking connection can also be referred to as an adhesion or adhesive bond. In particular, the at least one bipolar plate and the at least one gas diffusion layer are glued together by the coating. The coating may also be referred to as glue or adhesive.

Preferably, the coating has a low transition resistance between the at least one bipolar plate and the at least one gas diffusion layer. The transition resistance is in the order of 50 mm Ohm×cm 2. In particular, a constriction resistance RE is low at the transition from the at least one bipolar plate to the at least one gas diffusion layer.

Preferably, the coating comprises the coating material and the coating material further preferably includes an electrically conductive filler. In particular, the coating consists of the coating material containing the electrically conductive filler. A filler content is between 5% and 95%, preferably between 50% and 95%. For example, chemically, the material may be an epoxy, an acrylate, polyurethane silicone, or polyester, or a mixture of these materials.

Preferably, the electrically conductive filler comprises graphite and/or a metal, such as silver. Further preferably, the electrically conductive filler consists of graphite and/or the metal, such as silver, in particular silver.

The coating material can be a one-component adhesive or a two-component adhesive. Preferably, the coating material has a thixotropies flow behavior prior to curing. A thixotropic behavior is understood to mean that the viscosity of the coating material decreases as a result of continuous external influences and, after being stressed, again assumes the starting viscosity.

Preferably, the coating is applied to the at least one bipolar plate. Further preferably, the coating is applied only to parts of the bipolar plate. Particularly preferably, the at least one bipolar plate comprises connecting portions and the coating is applied to the connecting portions, in particular only on parts of the connecting portions. The coating may be applied to a cathode side and/or an anode side of the bipolar plate.

Due to the thixotropic flow behavior, the coating material is flowable during application and can be applied precisely, in particular on the connecting portions of the at least one bipolar plate. After applying, which can also be referred to as administering, the viscosity of the coating material increases abruptly so that the coating material remains on the connecting portions and does not flow off.

Preferably, the connecting portions of the at least one bipolar plate each have a connecting portion width in a range from 0.3 mm to 1.5 mm, further preferably from 0.5 mm to 1 mm. Further preferably, the connecting portions of the at least one bipolar plate are arranged at distance from one another in a range from 1 mm to 2 mm, further preferably from 1.25 mm to 1.60 mm. Preferably, there are troughs between the connecting portions, which may also be referred to as channels. The troughs preferably have a depth in a range from 0.25 mm to 0.75 mm, further preferably from 0.45 mm to 0.60 mm. On the connecting portions, there is preferably a contact to the at least one gas diffusion layer with a contact width in a range from 0.1 mm to 0.5 mm, further preferably from 0.15 mm to 0.3 mm. Preferably, the coating material covers at least the contact width of the connecting portions.

The curing of the coating material is preferably carried out at a temperature in a range from 10° C. to 90° C., further preferably from 15° C. to 80° C.

The electrically conductive coating can be applied, for example, by metering or screen printing methods. For the screen printing method, a plurality of regions of the at least one bipolar plate are coated, in particular simultaneously and selectively. The proportion of the surface of the bipolar plate that has a coating is between 5% and 50%. During metering, preferably amounts of the coating material are applied in a range of 0.001 ml to 9 ml per metering procedure and position.

Preferably, the at least one bipolar plate and/or the at least one gas diffusion layer are pre-treated with plasma prior to application of the electrically conductive coating.

Also, the at least one gas diffusion layer together with the at least one, in particular catalyst-coated, membrane can form a membrane-electrode assembly, wherein the at least one bipolar plate is correspondingly connected to the at least one gas diffusion layer of the membrane-electrode assembly.

Preferably, the at least one gas diffusion layer comprises a mesoporous layer (MPL). Also, the mesoporous layer, the at least one membrane and/or a frame of the membrane-electrode unit, which can also be referred to as a gasket, can be pretreated with plasma.

Pre-treatment with plasma enhances adhesive forces, wherein the plasma generates reactive groups on the surface so that the coating material can covalently bond to it. For example, a covalent bond of carbon fibers can be made via amine groups with an epoxy. The pre-treatment with plasma is carried out in particular in an atmosphere containing air, in particular oxygen. The atmosphere can include NH₃, N₂, SO₂, H₂O, and/or air, among others. Nozzles of various embodiments can be used for pre-treatment with plasma.

The pretreatment with plasma is preferably carried out immediately prior to application of the electrically conductive coating. In this case, shadow masks can be used so that the pre-treatment with plasma is only carried out in selected regions. Also, in particular, the at least one membrane and/or the at least one gas diffusion layer can be pre-treated with plasma prior to being assembled into the membrane electrode assembly, in particular by gluing.

Preferably, application of the electrically conductive coating is performed prior to stacking. Further preferably, the curing is performed after stacking.

Preferably, all bipolar plates contained in the fuel cell stack are connected to the respective adjacent gas diffusion layer by means of the coating.

By connecting the at least one bipolar plate to the at least one gas diffusion layer by means of the electrically conductive coating, an improved electrical contact is made between the bipolar plate and the gas diffusion layer, wherein simultaneously a force such as a pressing force acting on the gas diffusion layer can be significantly reduced or completely avoided. Thus, damage to the gas diffusion layer, in particular damage to the fibers or a decrease in porosity, can be avoided and a gas distribution can be improved. A transition resistance between the bipolar plate and the gas diffusion layer is reduced. Compressing the fuel cell stack to ensure sufficiently good electrical contact becomes unnecessary.

In addition, the coating prevents the gas diffusion layer or membrane-electrode assembly from slipping on the bipolar plate when stacking the fuel cell stack.

Furthermore, compared to a connection by welding, for example, only low curing temperatures are required for electrically conductive bonding, which correspond to the application temperatures of the fuel cell.

### BRIEF DESCRIPTION OF THE DRAWINGS

Embodiments of the invention are explained in greater detail with reference to the drawings and the following description.

Shown in the drawings are:

FIG. 1 a fuel cell stack according to the prior art,

FIG. 2 a fuel cell stack according to the invention,

FIG. 3 a bipolar plate,

FIG. 4 a cross section of a bipolar plate,

FIG. 5 a section of a cross section of a bipolar plate and,

FIG. 6 a schematic representation of a method for producing a fuel cell stack.

### DETAILED DESCRIPTION

In the following description of the embodiments of the invention, identical or similar elements are denoted by identical reference signs, wherein a repeated description of these elements is omitted in individual cases. The figures illustrate the subject matter of the invention merely schematically.

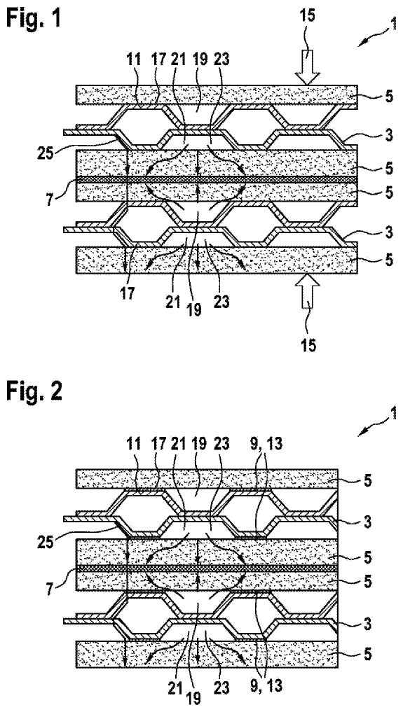

FIG. 1 shows a fuel cell stack 1 according to the prior art. The fuel cell stack 1 comprises a layering of bipolar plates 3 and gas diffusion layers 5. Furthermore, a membrane 7 is shown. By a pressing force 15, an electrical contact 17 is made between a respective gas diffusion layer 5 and a bipolar plate 3. On the one hand, hydrogen 19 and, on the other hand, air 21 and water 23 flow through the bipolar plates 3, each of which passes through a gas diffusion layer 5 to the membrane 7 or is removed from it. Furthermore, electrons 25 are passed through the bipolar plates 3.

FIG. 2 shows a fuel cell stack 1 according to the invention. In contrast to the fuel cell stack 1 according to the prior art according to FIG. 1, there is no pressing force 15 on the fuel cell stack 1 shown in FIG. 2. According to FIG. 2, an electrical contact 17 is made between a gas diffusion layer 5 and a bipolar plate 3 by a coating 9 that is electrically conductive and comprises a coating material 13. In the above context, “electrically conductive” means an electrical conductivity that is greater than 100 S/m. The coating 9 is arranged between a gas diffusion layer 5 and a bipolar plate 3 and connects them to one another in a material-locking and a form-locking fashion. Furthermore, the coating 9 is arranged locally on connecting portions 11 of the bipolar plates 3.

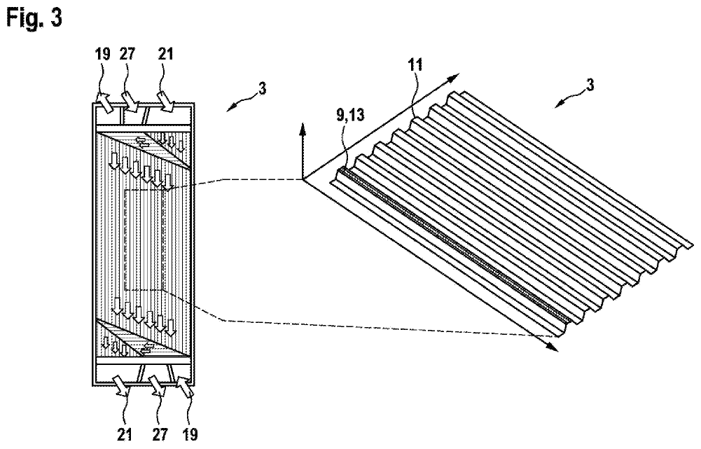

FIG. 3 shows a bipolar plate 3 in a top plan view as well as a section of the bipolar plate 3 in a perspective view. Hydrogen 19 and air 21 are supplied, and unused hydrogen 19 and unused air 21 are discharged. In addition, a cooling medium 27 is passed through the bipolar plate 3.

Furthermore, a schematic illustration of a section of the center of the bipolar plate 3 is shown, where connecting portions 11 of the bipolar plate 3 can be seen. The coating 9 is arranged on a connecting portion 11 shown.

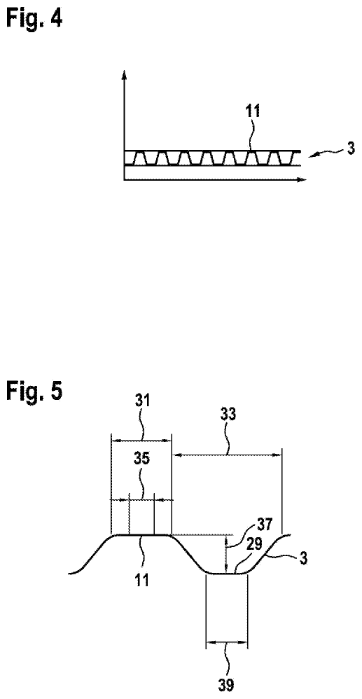

FIG. 4 shows a section of the bipolar plate 3 according to FIG. 3 in a cross-sectional view. The undulating profile of the bipolar plate 3 with the connecting portions 11 becomes clear.

FIG. 5 shows a section of a cross-sectional view of a bipolar plate 3. The bipolar plate 3 comprises connecting portions 11 and troughs 29. The connecting portions 11 have a connecting portion width 31 and are at a distance 33 to each other. A contact width 35 is present on the connecting portions 11. The troughs 29 have a depth 37 and a trough width 39.

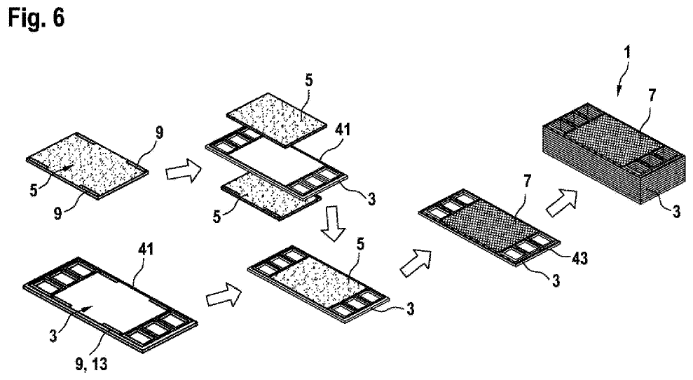

FIG. 6 shows a schematic representation of a method for producing a fuel cell stack 1. Two gas diffusion layers 5 are partially provided with a coating 9. Between the gas diffusion layers 5 comprising the coating 9, a bipolar plate 3 is arranged with a seal 41 and connected to the gas diffusion layers 5 by the coating 9 in a material-locking manner.

Alternatively, a bipolar plate 3, which already comprises a seal 41, can be partially provided with the coating 9. Two gas diffusion layers 5 can then be arranged on one side of the bipolar plate 3 each. A membrane 7 with a gasket 43 is placed on the gas diffusion layers 5. A plurality of bipolar plates 3 with gas diffusion layers 5 and membranes 7 are stacked to the fuel cell stack 1.

The invention is not limited to the exemplary embodiments described herein and the aspects highlighted thereby. Rather, within the range specified by the claims, a large number of modifications are possible which lie within the abilities of a skilled person.

1. A fuel cell stack (1) comprising at least one bipolar plate (3), at least one gas diffusion layer (5) and at least one electrolyte, wherein a coating (9) is arranged as a connecting means between the at least one bipolar plate (3) and the at least one gas diffusion layer (5) and the coating (9) is electrically conductive.

2. The fuel cell stack (1) according to claim 1, wherein the at least one bipolar plate (3) and the at least one gas diffusion layer (5) are connected to each other by means of the coating (9) in a material-locking and/or a form-locking manner.

3. The fuel cell stack (1) according to claim 1, wherein the coating (9) comprises a coating material (13) and the coating material (13) contains an electrically conductive filler.

4. The fuel cell stack (1) according to claim 3, wherein the electrically conductive filler comprises graphite and/or a metal.

5. The fuel cell stack (1) according to claim 1, wherein the at least one bipolar plate (3) comprises connecting portions (11) and the coating (9) is applied to the connecting portions (11).

6. A method for producing a fuel cell stack (1) according to claim 1, the method comprising the steps of:
a. providing the at least one bipolar plate (3), the at least one gas diffusion layer (5) and the at least one electrolyte,
b. applying the electrically conductive coating (9) onto the at least one bipolar plate (3) and/or the at least one gas diffusion layer (5), wherein the coating (9) comprises a coating material (13),
c. stacking the at least one bipolar plate (3), the at least one gas diffusion layer (5) and the at least one electrolyte,
d. connecting the at least one bipolar plate (3) and the at least one gas diffusion layer (5) by means of the electrically conductive coating (9), such that electrical contact is made between the at least one bipolar plate (3) and the at least one gas diffusion layer (5), and
e. curing the coating material (13).

7. The method according to claim 6, wherein the at least one bipolar plate (3) and/or the at least one gas diffusion layer (5) are pre-treated with plasma prior to application of the electrically conductive coating (9).

8. The method according to claim 6, wherein the coating material (13) has a thixotropic flow behavior prior to curing.

9. The method according to claim 6, wherein the curing of the coating material (13) is carried out at a temperature in a range from 10° C. to 90° C.

10. The method according to claim 6, wherein the at least one bipolar plate (3) and the at least one gas diffusion layer (5) are stacked with a contact pressure of less than 1.4 N/mm².

11. The fuel cell stack (1) according to claim 1, wherein the at least one electrolyte includes at least one membrane (7).

12. The fuel cell stack (1) according to claim 11, wherein the at least one bipolar plate (3) and the at least one gas diffusion layer (5) are connected to each other by means of the coating (9) in a material-locking and/or a form-locking manner.

13. The fuel cell stack (1) according to claim 12, wherein the coating (9) comprises a coating material (13) and the coating material (13) contains an electrically conductive filler.

14. The fuel cell stack (1) according to claim 13, wherein the electrically conductive filler comprises graphite and/or a metal.

15. The fuel cell stack (1) according to claim 14, wherein the electrically conductive filler comprises silver.

16. A method for producing a fuel cell stack (1) according to claim 11, the method comprising the steps of:
a. providing the at least one bipolar plate (3), the at least one gas diffusion layer (5) and the at least one membrane (7),
b. applying the electrically conductive coating (9) onto at least one of the at least one bipolar plate (3) and the at least one gas diffusion layer (5), wherein the coating (9) comprises a coating material (13),
c. stacking the at least one bipolar plate (3), the at least one gas diffusion layer (5) and the at least one membrane (7),
d. connecting the at least one bipolar plate (3) and the at least one gas diffusion layer (5) by means of the electrically conductive coating (9), such that electrical contact is made between the at least one bipolar plate (3) and the at least one gas diffusion layer (5), and
e. curing the coating material (13).

17. The method according to claim 16, wherein step b includes applying the electrically conductive coating (9) onto both of the at least one bipolar plate (3) and the at least one gas diffusion layer (5).

18. The method according to claim 16, wherein step b includes applying the electrically conductive coating (9) onto only the at least one bipolar plate (3).

19. The method according to claim 16, wherein step b includes applying the electrically conductive coating (9) onto only the at least one gas diffusion layer (5).

20. The method according to claim 16, wherein the at least one of the at least one bipolar plate (3) and the at least one gas diffusion layer (5) is pre-treated with plasma prior to application of the electrically conductive coating (9).
